(19) United States
(12) Patent Application Publication
(10) Pub. No.: US 2008/0082179 A1
(43) Pub. Date: Apr. 3, 2008

(54) Eye guard with voice indication

(76) Inventor: Yea-Chyi Yang, Yingge Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/528,507

(22) Filed: Sep. 28, 2006

(51) Int. Cl. G05B 11/01; G05B 15/00; G08B 3/00

(52) U.S. Cl. 700/17; 700/83; 340/691.1

(57) ABSTRACT

An eye guard with voice indication is provided, and it includes an eye guard body, a filter, a display device and a voice output device. The display device is mounted inside the eye guard body to display a circumstance value or operating condition information. Furthermore, the voice output device is electrically connected with the display device and includes a main controller, a power supply, a sound output controller, a sensor circuit and a drive circuit. The sensor circuit has at least one sensor exposed on an external surface of the eye guard body and defined in a supposed centerline of the filter to detect the surrounding circumstance. Thus, the circumstance value and the operation condition information are noticed in the form of voice and vision simultaneously for the operators.

### BACKGROUND

1. Field of Invention

The present invention relates to an eye guard, and more particularly to an eye guard with voice indication whereby a voice is generated to inform the user during the operation.

2. Description of Related Art

The conventional welding eye guard protects users from not only spurted solder and melted debris of workpieces but also radiation during the welding process. Thus, the common eye guard has a filter to resist radiation and protect users from personal injury. The prior filter is manufactured with plastic or glass to form a passive filter with a constant shade. As the development of technology, the current filter is already manufactured with liquid crystal to form an active filter with auto darkening functions. This liquid crystal filter resists radiation, protects users from spurted solder or melted debris of workpieces during the melting process and also combines a control circuit, a light emitting diode (LED) and a liquid crystal display (LCD). In this way, the operation condition, the luminosity, the sensitivity, the recovery time, the battery capacitance, the welding modes, the power signal, the awaken mode, the sleep mode and the warning signal can be shown with the light, the scale or numerals to inform the user about the current surrounding circumstances.

Although the conventional eye guard with the control circuit and the liquid crystal display (LCD) can achieve the previous purposes, the light, the scale or the numerals belong to a kind of silent indication. Therefore, the operators are warned only with visual images such that a blind point may occur. Generally, the welding eye guards are divided into two kinds of eye guards, the hand-held mask eye guard and the helmet eye guard. The hand-held mask eye guard only shields the operator's face and the helmet eye guard completely covers the operator's head. If the liquid crystal display (LCD) is implemented on the helmet eye guard, the location and the direction of the liquid crystal display (LCD) should be considerable, or blind points occur. If so, the indication function is unavailable and the personal security of the operators is also threatened. For the welding helmet with the liquid crystal display (LCD), the shade in the helmet is too dark to clearly see the information presented on the LCD when the auto darkening filter (ADF) transforms to a dark state or recovers to lightening. For the method using a tuning knob to indicate dark scales, the scales are also vaguely seen when operating at night or in dark environments without sufficient light. Beside, the visible angle of the LCD is limited (<60°), the contrast is lower and the reaction speed is also slow.

The liquid crystal display (LCD) uses the reflective theory because the LCD does not have the self-illumination function such that the information presented on the LCD cannot be easily seen at night or in dark environments. Thus, it is necessary to add a back light module or a color filter to make a color display. However, these additions increase the power consumption, the material cost and the fabrication steps such that the price is raised accordingly.

Considering the convenience of the operation, partial or all adjustable tuning knobs are set in the control box outside the welding helmet. By this method, the operator can work and adjust or select the functions simultaneously, but the presented scale cannot be seen during the operation. When the operator adjusts the tuning knobs, the operator cannot see the scales so that the operator always adjusts the tuning knobs following the operator's instincts during welding. Thus, potential hazards may be occurred.

Additionally, the adjustable knobs can also be combined with the auto-darkening filter (ADF) to be compatible with various welding helmets, the user has to set all the adjustable knobs before wearing the welding helmet. Yet, if the user wants to confirm the information when the interior shade of the welding helmet is too dark for the user to see, the user has to take off the welding helmet to confirm the information. Consequently, this kind of welding helmet wherein the adjustable knobs are combined with the auto-darkening filter (ADF) extends the working time and affects the welding operation.

For some eye guards, the sensor location is inappropriately moved to prevent the sensor from being covered by other objects. In this way, the sensor cannot normally detect the surrounding circumstance such that the personal injury may occur.

### SUMMARY

It is therefore an objective of the present invention to provide an eye guard with voice indication to solve the vague and the blind point problems of the conventional eye guard consisting of an LED or an LCD to present the surrounding environmental information.

It is another objective of the present invention to provide an eye guard with voice indication to solve the self-illumination and the visible angle limitation problems of a conventional LCD.

It is another objective of the present invention to provide an eye guard with voice indication to solve the problem that the sensor cannot normally detect the surrounding environmental parameters because of the improper location of the sensor.

An eye guard with voice indication is provided, and it includes an eye guard body, a filter, a display device and a voice output device. The filter is mounted in an opening of the eye guard body to filter the light. The display device is mounted inside the eye guard body to display circumstance value or operating condition information. The voice output device is electrically connected with the display device and includes a main controller, a power supply, a sound output controller, a sensor circuit and a drive circuit. The main controller has a voice control unit. The power supply is electrically connected with the main controller. The sound output controller is electrically connected with the main controller. The sensor circuit has at least one sensor mounted in the eye guard body. The drive circuit is electrically connected between the main controller and the filter.

Compared with the conventional eye guard with visual images, the eye guard with voice indication of the present invention co-ordinates the voice output function with the eye guard function. Thus, the user directly receives information about the surrounding environmental conditions in the form of a voice during the welding operation without depending on the instincts of the welder or the visual images. Consequently, the user can concentrate on operating the welding machine with less interference.

The conventional eye guard using the light emitting display (LED) or light crystal display (LCD) results in some problems such as high power consumption, complex information cannot be shown, the limited visible angle, low contrast and slow reaction. Thus, the eye guard with the voice indication of the present invention takes advantage of the self-illumination feature of the flat panel display (FPD) to save power, enhance the shade, strengthen the contrast and accelerate the reaction. Besides, the viewing angle is no longer limited and even more than 160°.

The eye guard with voice indication of the present invention further includes a light emitting assisted display mounted in the eye guard body to provide warning effects or classify different operator groups.

By applying a light emitting flat panel display (FPD) to the display device and the assisted display, the warning effect of the welding light can be shown to inform surrounding people to notice the glare. The flat panel display (FPD) of the present invention can self-illuminate such that the vague and the blind point problems of the conventional eye guard can be solved.

The eye guard with voice indication of the present invention further includes a plurality of film keys mounted on a touch panel. By this method, the thickness can be reduced and the waterproof effect can also be enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a front view of the embodiment of a helmet with an eye guard with voice indication in accordance with the present invention;

FIG. 2 is a side view of the helmet in FIG. 1;

FIG. 3 shows a front view of the body of the embodiment of the eye guard with voice indication of the present invention;

FIG. 4 shows a back view of the body of the embodiment of the eye guard with voice indication of the present invention;

FIG. 5 shows a block diagram of the embodiment of the eye guard with voice indication of the present invention; and

FIG. 6 shows a perspective view of another embodiment of a hand-held mask with eye guard with voice indication.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

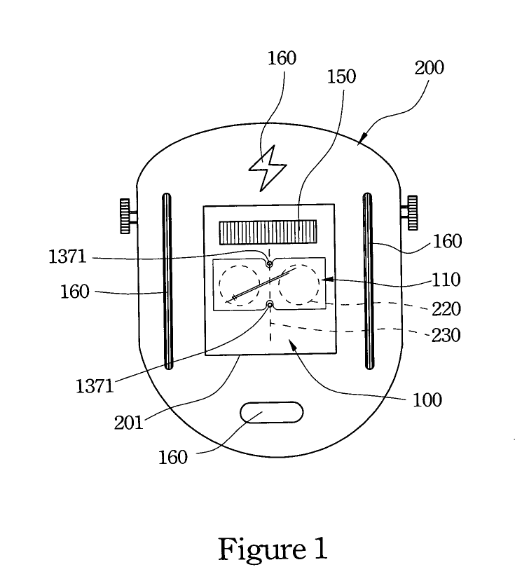

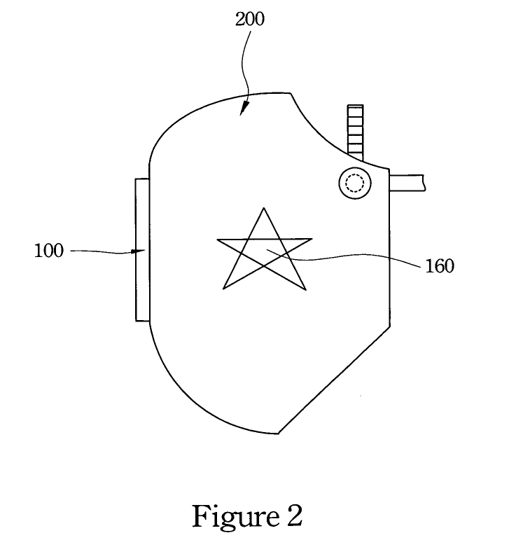

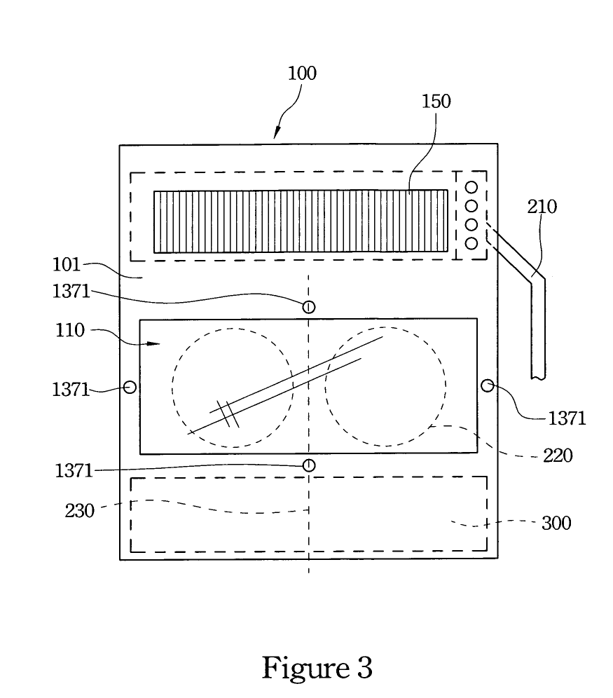

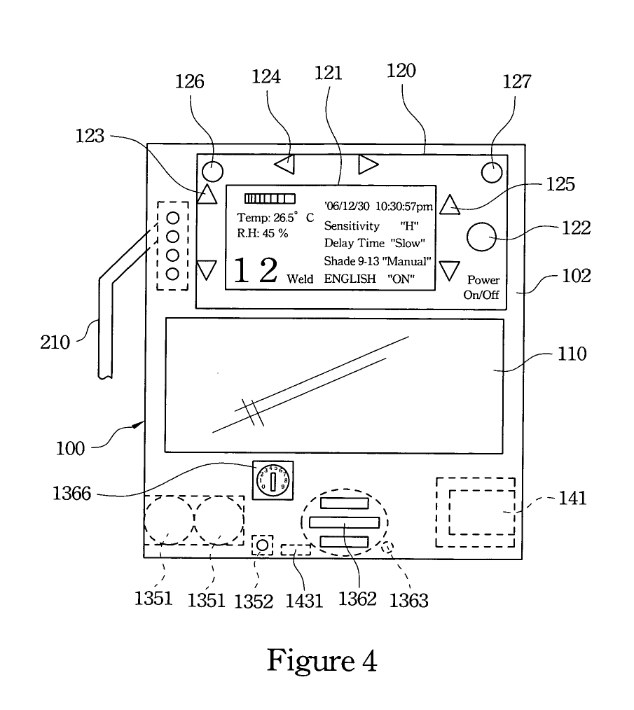

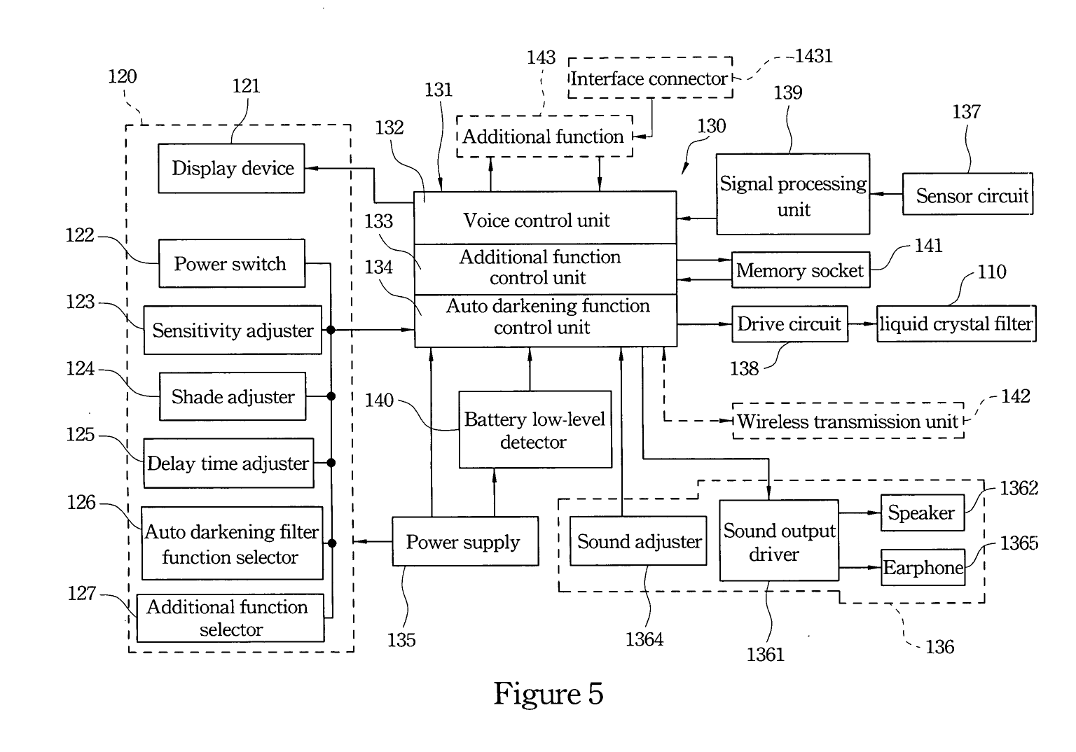

Refer to the figures from FIG. 1 to FIG. 5. FIG. 1 is the embodiment of an eye guard with voice indication. FIG. 2 is a side view of FIG. 1. FIG. 3 is a front view (external surface 101) of the body of the embodiment of the eye guard with voice indication. FIG. 4 is a back view (internal surface 102) of the body of the embodiment of the eye guard with voice indication. FIG. 5 is a block diagram of the embodiment of the eye guard with voice indication.

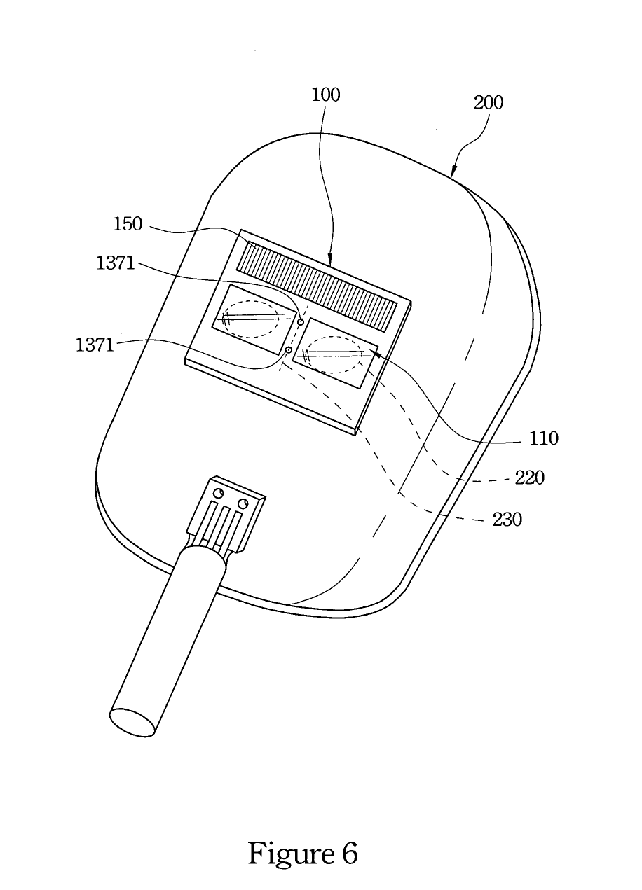

An eye guard with voice indication of the present invention includes an eye guard body 100, a filter 110, a touch panel 120, a display device 121 and a voice output device 130. The above components can be applied to the hand-held mask eye guard in FIG. 6 or the helmet eye guard in FIG. 1 and FIG. 2.

A shield 200 (mask or helmet) has an opening 201 and the body 100 is mounted in the opening 201 of the shield 200.

The filter 110 is mounted on the eye guard body 100 to resist infrared and ultraviolet rays and filter the light. In the embodiment, the filter 110 is a liquid crystal filter.

Refer to FIG. 3, FIG. 4 and FIG. 5. The touch panel 120 includes the display device 121 and a plurality of film keys, 122, 123, 124, 125, 126 and 127. The display device 121 is electrically connected with the voice output device 130 and is mounted inside the body 100 to display values of surrounding environmental parameters or information about the operating condition. The display device 121 is a light emitting flat panel display (FPD) and may be the plasma display panel (PDP), the vacuum fluorescent display (VFD), the field emission display (FED), the electro luminescent display (ELD), the electrochromic display (ECD), the electrophoretic display (EPID) or PLZT. The electro luminescent display (ELD) includes an organic light emitting display (OLED), a polymer light emitting display (PLED), organic electro luminescent display (OELD) or inorganic light emitting display.

The touch panel 120 is electrically connected with the voice output device 130 and the display device 121. The film keys of the touch panel 120 have a power switch 122, a sensitivity adjuster 123, a shade adjuster 124, a delay time adjuster 125, an auto darkening filter function selector 126 and an additional function selector 127. The auto darkening filter function selector 126 further includes darkening auto/manual adjuster or welding/cutting/grinding selector. The sensitivity adjuster 123, the shade adjuster 124 and the delay time adjuster 125 are controlled by the keys “Δ” and “∇” to adjust the function range.

Refer to FIG. 3 and FIG. 5. The voice output device 130 is mounted on a control circuit board 300 and includes a main controller 131, a power supply 135, a sound output controller 136, a sensor circuit 137, a drive circuit 138, a signal processing unit 139 and a battery low-level detector 140. The main controller 131 has a voice control unit 132, an additional function control unit 133 and an auto darkening function control unit 134. The drive circuit 138 is electrically connected between the main controller 131 and the filter 110. The signal processing unit 139 is electrically connected between the main controller 131 and the sensor circuit 137. The battery low-level detector 140 is electrically connected between the main controller 131 and the power supply 135.

The voice control unit 132 of the main controller 131 is a core control circuit for voice output in the voice output device 130. The voice control unit 132 has various language databases (Chinese, English or Japanese etc.) and controls the output of the audio signal.

Refer to FIG. 3, FIG. 4 and FIG. 5. The power supply 135 is used to provide the power for the main controller 131. In this embodiment, a solar cell 150 is used as the power supply 135 such that solar energy can be stored in two batteries 1351 to supply the power. In order to extend the supply period, a wire connector method can be applied for power supply. In the wire connection method, the transformer (not shown) is used to transform the power and a DC jack 1352 is used to charge the battery 1351 with the general power (110V/220V) or high volume battery when the capacitance of the battery 1351 is low.

The battery low-level detector 140 is used to detect the capacitance of the power supply 135. When the battery 1351 capacitance is low, the battery low-level detector 140 notices the voice control unit 132 of the main controller 131 to send the “low power” voice signal. Thus, the operator is notified when the battery need to be charged, changed, or connected to power lines.

Refer to FIG. 4 and FIG. 5. The sound output controller 136 includes a sound output driver 1361, a speaker 1362, an earphone socket 1363 and a sound adjuster 1364. Before the voice signal is outputted by the voice control unit 132, the voice signal is transformed into the sound frequency signal by the sound output driver 1361 and the voice in the voice control unit 132 is played by the speaker 1362. The voice can also be received by wearing an earphone 1365 when the earphone 1365 is plugged-in the earphone socket 1363. The sound adjuster 1364 has the control functions for the sound switch, volume and language settings such that the operator can turn on/off the sound, adjust the volume and change various language.

Refer to FIG. 1, FIG. 3, FIG. 5 and FIG. 6. The sensor circuit 137 is used to detect the external circumstance with the sensor 1371. Furthermore, the sensors 1371 can be two sensors exposed on the external surface 101 and defined in the supposed centerline 230 of the filter 110. The sensors 1371 can also be four sensors arranged along the centerline 230 and the opposite flanks of the filter 110 as shown in FIG. 3. When the circumstance value is detected by the sensors 1371, the circumstance value is processed by the signal processing unit 139 to amplify, rectify and filter. After the voice control unit 131 procedure, a voice signal is outputted by the speaker 1362 (or the earphone 1365) of the sound output controller 136 when the circumstance is changed or different from the initial setting. Thus, the warning effect is obtained by the notification voice of the circumstance value or operating condition information. Furthermore, the two sensors 1371 exposed on the external surface 101 and defined in the supposed centerline 230 of the filter 110 can be used to detect the external welding light. The other two sensors 1371 arranged in the opposite flanks of the filter 110 can be used to detect the temperature and the moisture.

Refer to FIG. 4 and FIG. 5. The voice output device 130 further includes a memory socket 141, a wireless transmission unit 142 and an additional function 143. The memory socket 141 is used to access the sound data and audio data of various memory cards to update or add the voice data. The various memory cards can be the CF, SD, xD, MiniSD, MicroSD, MMC, RS-MMC, MS Pro Duo and T-Fish. The wireless transmission unit 142, a bluetooth or an infrared system, is used to transmit other functions. In FIG. 5, an interface connector 1431 is set in the body 100 to connect with the electrical devices to provide the additional function 143. The functions of the connected electrical devices can be partially or completely contained to the eye guard with voice indication by the IEEE-1394, USB1.1/2.0 or RS-232/RS-242 interfaces. The electrical devices can be GPS, PDA, phone, digital camera, temperature/moisture detector, radio, MP3/MP4 player, TV, clock/alarm, recorder, digital calendar or game.

Refer to FIG. 1 and FIG. 2. The eye guard with voice indication of the present invention further includes multiple assisted displays 160 exposed on the shield 200 to provide warning effects. The assisted displays 160 are light emitting flat panel display (FPD) configured in the form of the word, numeral, pattern, line, geometric picture or monochromatic/polychromatic/color pattern. The above display forms can be static or dynamic. Therefore, the assisted displays 160 exposed on the shield 200 are provided for warning effects when the user operates in a dark environment or at night. Additionally, using the assisted displays 160 with various numerals or patterns may identify and classify different operator groups.

The conventional eye guard containing light emitting diode (LED) has the drawback of that complex information cannot be shown and the display effect is not obvious. In addition, the conventional eye guard containing liquid crystal display (LCD) has the drawback that the LCD cannot self illuminate except by adding the back-light module or color filter and only provides visual identification effects. Consequently, the eye guard with voice indication of the present invention has the following efficiencies:

1. The eye guard with voice indication of the present invention co-ordinates with the voice output function and the eye guard function. The outputted voice indication is provided for the operators to inform about different circumstances and operation conditions during welding process. This method can improve that the operators only depend on the instincts or the visual images of the various circumstance information and operation conditions to weld. Thus, the operators can concentrate on operating with less interference.

2. The light emitting flat panel display (FPD) can be applied to the display device 121 and the assisted display 160 to warn the surrounding operators to notice the welding light.

3. Because of the self-luminance feature of the flat panel display, the power consumption can be reduced and the viewing angle limitation problem can also be solved. Furthermore, the shade, the contrast and the reaction speed can also be enhanced by using the flat panel display (FPD).

4. The touch panel is in the form of the film such that the hardness is lessened and the waterproof effect is enhanced.

5. The display device 121 of the present invention can be mounted in the eye guard body 100 and can also be mounted outside the eye guard body 100 by a power wire 210. Hence, the sound warning and the visual display are provided simultaneously during the operation with this eye guard with voice indication. As a result, the diverse information can be clearly noticed to prevent the operators from injury and boost the security.

6. The conventional sensors are inappropriately moved to be prevented from being covered by other objects. In this way, the sensor cannot normally detect the surrounding circumstance such that the user's eye would be injured. The sensors of the present invention are exposed on the external surface 101 and defined in the supposed centerline 230 of the filter 110. Thus, the problem caused by the arrangement of the conventional sensors can be solved.

Although the present invention has been described in considerable detail with reference to certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An eye guard with voice indication, comprising:
an eye guard body;
a filter mounted in an opening of the eye guard body;
a display device mounted inside the eye guard body to display a circumstance value or operating condition information; and
a voice output device electrically connected with the display device, and including:
a main controller including a voice control unit;
a power supply electrically connected with the main controller;
a sound output controller electrically connected with the main controller;
a sensor circuit having at least one sensor mounted in the eye guard body; and
a drive circuit electrically connected between the main controller and the filter;
whereby the eye guard provides a voice indication to an operator who wears the eye guard during welding operation.

2. The eye guard with voice indication of claim 1, wherein the display device has a touch panel.

3. The eye guard with voice indication of claim 1, wherein the display device is a light emitting flat panel display (FPD).

4. The eye guard with voice indication of claim 2, wherein the touch panel includes a plurality of film keys having multiple functions of power switch, sensitivity adjuster, shade adjuster, delay time adjuster, auto darkening filter function selector and additional function selector to control and adjust the functions of the eye guard.

5. The eye guard with voice indication of claim 1, wherein the voice output device further includes a signal processing unit electrically connected between the main controller and the sensor circuit.

6. The eye guard with voice indication of claim 1, wherein the voice output device further includes a wireless transmission unit and a memory socket electrically connected with the main controller.

7. The eye guard with voice indication of claim 6, wherein the wireless transmission unit is a bluetooth transmission system or an infrared ray transmission system, and the memory socket is used to access a block of sound data or audio data of various memory cards to update or add a voice data of the voice control unit.

8. The eye guard with voice indication of claim 3, wherein the flat panel display (FPD) is selected from the group consisting of a plasma display panel (PDP), a vacuum fluorescent display (VFD), a field emission display (FED), an electro luminescent display (ELD), an electrochromic display (ECD), an electrophoretic display (EPID) and PLZT display.

9. The eye guard with voice indication of claim 8, wherein the electro luminescent display (ELD) includes an organic light emitting display (OLED), a polymer light emitting display (PLED), organic electro luminescent display (OELD) and inorganic light emitting display.

10. The eye guard with voice indication of claim 1, wherein the sound output controller further includes a sound output driver, a speaker and a sound adjuster; the sound output driver transforms a voice signal into a sound frequency signal, and the speaker outputs a sound of the voice control unit.

11. The eye guard with voice indication of claim 1, wherein the filter is a liquid crystal (LC) filter.

12. The eye guard with voice indication of claim 1, further comprising a battery low-level detector electrically connected between the main controller and the power supply.

13. The eye guard with voice indication of claim 1, further comprising a shield on which the eye guard body is mounted.

14. The eye guard with voice indication of claim 13, further comprising multiple assisted displays exposed on the shield to provide warning effects or classify different operator groups.

15. The eye guard with voice indication of claim 14, wherein the assisted displays are flat panel displays (FPD) configured in the form of words, numerals, patterns, lines, geometric pictures or monochromatic/polychromatic/color patterns.

16. The eye guard with voice indication of claim 10, wherein the sound adjuster includes a power switch, a volume controller and a multi-language selector to turn on/off the sound, adjust the volume and change various language.

17. The eye guard with voice indication of claim 1, wherein the at least one sensor comprises multiples sensors exposed on an external surface of the eye guard body and arranged along a centerline of the filter between the human's eyes.
